(19) United States
(12) Patent Application Publication
(10) Pub. No.: US 2024/0155315 A1
(43) Pub. Date: May 9, 2024

(54) METHODS FOR PROVIDING IOT SERVICES TO AMBIENT IOT DEVICES IN WIRELESS SYSTEMS

(71) Applicant: INTERDIGITAL PATENT HOLDINGS, INC., Wilmington, DE (US)

(72) Inventors: Michael Starsinic, Conshohocken, PA (US); Saad Ahmad, Montreal (CA); Guanzhou Wang, Brossard (CA)

(73) Assignee: INTERDIGITAL PATENT HOLDINGS, INC., Wilmington, DE (US)

(21) Appl. No.: 18/501,841

(22) Filed: Nov. 3, 2023

Related U.S. Application Data
(60) Provisional application No. 63/422,294, filed on Nov. 3, 2022.

(51) Int. Cl. H04W 4/50; G06F 9/54; H04W 12/08; H04W 12/63; H04W 64/00

(52) U.S. Cl. CPC H04W 4/50; G06F 9/547; H04W 12/08; H04W 12/63; H04W 64/00; G16Y 30/10

(57) ABSTRACT

A procedure performed by a network node of providing an Ambient IoT service (AIS) is described. The procedure includes a network node receiving an API request from an application server to perform a procedure with one or more ambient IoT devices. The request may include a time duration. The network node invokes a UDM service UDM to check application servicer authorization to perform the procedure. The network node determines at least an AMF identity. The network node invokes an AMF service requesting the AMF initiate a procedure with one or more ambient IoT devices. A response is received from the AMF including at least one identifier of an Ambient IoT device. The network nodes sends a response to the application server, the response including the at least one identifier of an Ambient IoT device.

### CROSS-REFERENCE TO RELATED APPLICATIONS

This application claims priority to and incorporates by reference in its entirety U.S. provisional Application No. 63/422,294, filed on Nov. 3, 2022 and titled Methods for Providing IoT Services to Ambient IoT Devices in Wireless Systems.

### BACKGROUND

Internet of Things (IoT) devices often have very limited processing and energy storage capabilities and may work with a wireless network, such as a 5G network. A device may be non-battery powered or have very limited energy storage capabilities. For example, the device's energy storage may be limited to a capacitor. Compared to batteries, capacitors can only store energy for a relatively short amount of time.

A device may be an energy harvesting device. An energy harvesting device may be equipped with hardware and circuitry that is able to harvest energy from the environment. For example, energy may be harvest from a solar panel, a piezoelectric crystal, and RF signals. The harvested energy may be stored in a capacitor. Once the amount of energy that is stored in the capacitor exceeds a threshold the device may begin to perform operations such as collect a sensor reading, excite an actuator, send data to a network, and/or receive data from a network. The device may need to complete these operations before the amount of energy that is stored in the capacitor falls below a second threshold. When the amount of energy falls below the threshold, it may not be possible for the device to complete its operations. It should be noted that, in many cases, it may be expected that the device, when performing operations, will expend energy at a rate that is greater than the rate at which it can harvest energy. When the device is not performing operations, it may be considered to be in a sleep, inactive, or low power state.

Wireless systems, such as a 5G system, may be used to provide connectivity to devices such as NB-IoT device and CAT-M devices. These types of devices are well suited for applications that carry voice and some higher-end sensing applications. However, these types of devices require a battery in all practical implementations and target use cases that generally allow for energy storage in a battery and can be supported by devices that are relatively higher cost than the cost of an Ambient IoT Device.

### SUMMARY

A procedure performed by a network node of providing an Ambient IoT service (AIS) is disclosed. The procedure begins when the network node receives an API request from an application server to perform a procedure with one or more ambient IoT devices. The request may include a time duration. Next the network node invokes service of a UDM to check if the application servicer is authorized to perform the requested operation. Then the network node determines at least an AMF identity. Then the network node invokes an AMF service to request that the AMF initiate a procedure with one or more ambient IoT devices. A response is then received from the AMF, the response including at least one identifier of an Ambient IoT device. Finally, the network nodes sends a response to the application server, the response including the at least one identifier of an Ambient IoT device. The API request may include location information, or Ambient IoT Device identifiers. The location information may be used to determine at least one AMF identity. The procedure that is requested in the API request may be a mobile originating (MO) data collection procedure. The location information may include a last known location of at least one of the ambient IoT devices and the AMF identity may be determined based on the last known location of at the least one of the ambient IoT devices.

In further embodiments, the API request may include location information, or ambient IoT device identifiers. In further embodiments, the location information is used to determine at least one AMF identity. In further embodiments, the procedure that is requested in the API request is a mobile originating (MO) data collection procedure. Further embodiments may include providing the AMF with location information and/or ambient IoT device identifiers. In further embodiments the response from the AMF service includes at least an ambient IoT device identity and MO data. In further embodiments the response from the AMF Service includes at least an ambient IoT device identity and an indication of whether MT data was delivered to the ambient IoT device or the location of the ambient IoT device. In further embodiments the response to the Application Server includes at least an ambient IoT device identity and an indication of whether MT data was delivered to the ambient IoT device or the location of the ambient IoT device. In further embodiments the location information includes a last known location of at least one of the ambient IoT devices and the AMF identity is determined based on the last known location of at the least one of the ambient IoT devices.

In further embodiments, a network node for providing an Ambient IoT service (AIS), is configured to perform any of the above-described methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example process performed by a network node of performing an Ambient IoT service; and

FIG. 3 is a further example process performed by a network node of performing an Ambient IoT service.

### DETAILED DESCRIPTION

The following abbreviations and Acronyms are referred to throughout.

AMF Access and Mobility Function

AIS Ambient IoT Service

API Application Programing Interface

CAT-M Category MTC

ID Identifier

IE Information Element

IoT Internet of Things

MIB Master Information Block

MM Mobility Management

MNO Mobile Network Operator

MO Mobile Originated

MT Mobile Termination

MTC Machine Type Communication

NAS Non-Access Stratum

NB Narrowband

NEF Network Exposure Function

NRF Network Repository Function

PCF Policy Control Function

PDU Protocol Data Unit

PLMN Public Land Mobile Network

RAN Radio Access Network

RRC Radio Resource Control

SB Southbound

SIB System Information Block

UDM User Data Management

UDR User Data Repository

UE User Equipment

URSP UE Route Selection Policy

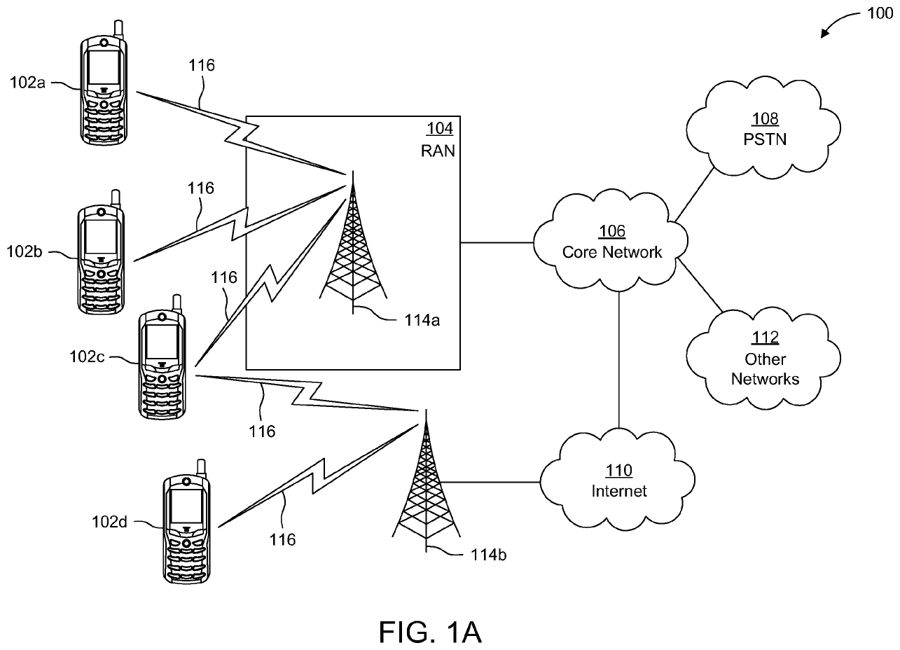

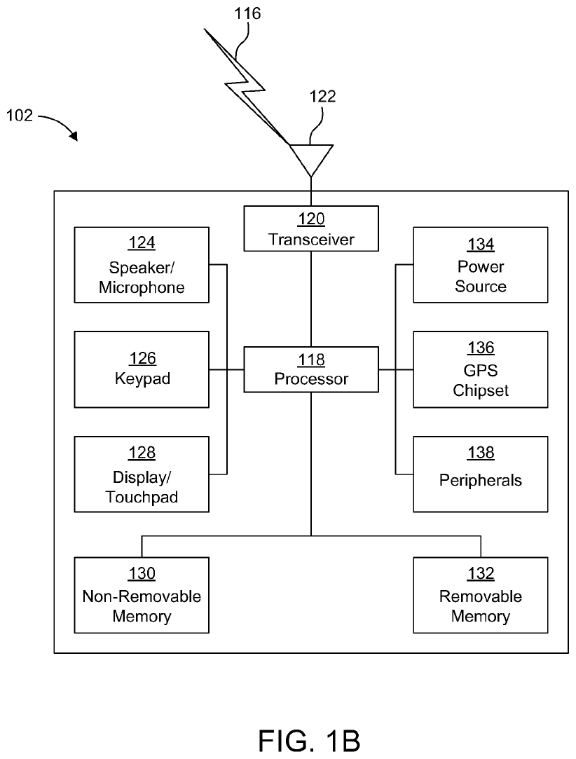

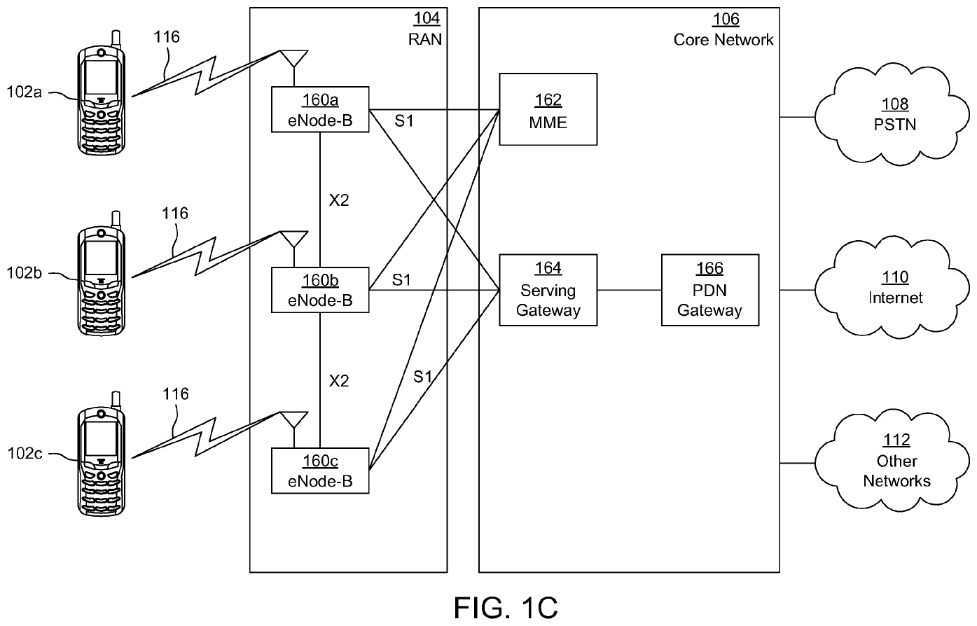

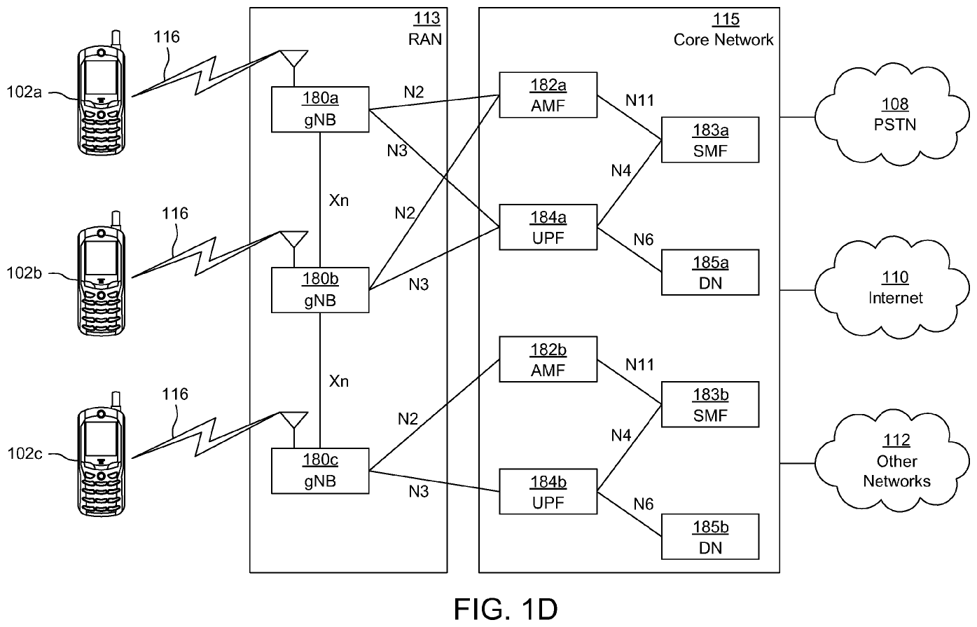

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA-F). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An example Ambient IoT use case may be an automated warehouse. For example, ambient IoT devices may be delivered to an automated warehouse. When the devices are delivered to the warehouse it is desired that they quickly connect to the automated warehouse's network and make their presence known. Ambient IoT devices may be stored in an automated warehouse. When the devices are stored in the warehouse it is desired that the network can quickly collect information from the devices (e.g., sensor readings, information about their presence in the warehouse, or their location). Ambient IoT devices may be delivered from an automated warehouse. When the devices are delivered from the warehouse it is desired that they quickly connect to the automated warehouse's network when passing out an “exit gate” so that the fact that they left the warehouse can be detected by the network.

The network of the automated warehouse provides an Ambient IoT Service to an inventory management system that is hosted on a third party application server. The Ambient IoT Service may collect information from the devices, send information to the devices, collect information about the devices, and configure the devices on behalf of the inventory management system.

5G networks have supported NB-IoT/MTC devices. NB-IoT and CAT-M devices support many types of MTC applications, however they are not well suited for certain types of applications. For example, there are some IoT use cases where it is not practical to equip a device with a battery. There are also IoT use cases where devices are expected to have very long service lives. Devices with long service lives should require little to no maintenance (e.g., battery changes). There are also use cases where the device needs to be washable and have a flexible form factor. NB-IoT and CAT-M devices are not well suited for these types of applications; therefore, existing 5G systems do not support such applications.

A device that does support the types of applications that are listed above is called an Ambient IoT Device. Ambient IoT Devices might not include a conventional battery. Ambient IoT Devices might harvest energy from the environment and store the energy in a capacitor and/or a very small battery. Ambient IoT Devices can harvest energy from radio waves, light, vibration, heat, pressure and other power sources.

Ambient IoT Devices may work well in applications such as smart logistics, smart warehouse, smart agriculture, asset tracking, environmental sensing, fault sensing, smart home, and smart clothing.

5G System enhancements are required to support Ambient IoT Devices. For example, 5G System enhancements may be required so that components in the 5G System (e.g., WTRUs and Base Stations) know when to broadcast energy that can be harvested by Ambient IoT Devices.

In another example, new methods are required to allow components in the 5G System (e.g., WTRUs and Base Stations) to trigger Ambient IoT Devices to initiate communication with the network. In another example, new methods are required to allow Ambient IoT Devices to trigger the 5G System to broadcast energy that can be harvested by the Ambient IoT Device so that the Ambient IoT Device can send information to the network. In another example, MO transmission procedures that allow a WTRU to quickly send data to the network and return to a sleep, or low power, state are desired. This is desirable because a device might be capable of storing only a very small amount of energy and taking a relatively long time to listen to the network in order to find a proper time to send data and then transmit the data might consume too much energy. In another example, MT transmission procedures that allow a WTRU to quickly receive data to the network and return to a sleep, or low power, state are desired. This is desirable because a device might be capable of storing only a very small amount of energy and taking a relatively long time to listen to the network in order to receive data might consume too much energy.

The information that is provided by or to Ambient IoT Devices typically originates from, or is sent to, a third party Application Server. IoT Devices traditionally communicate by sending and receiving data directly to/from the third party Application Server. Direct communication between an Ambient IoT Device and an Application Server might not be desirable because the relatively long communication delays between the Ambient IoT Device and Application Server might cause the Ambient IoT Device to consume too much energy while waiting for data, an acknowledgement, a response, or a handshake from the Application Server. Therefore, in addition to enhancing the 5G System to support MO and MT communication with Ambient IoT Devices, the 5G System should also support deployment of an Ambient IoT Service. An Ambient IoT Service may be functionality that is deployed by an MNO and can reduce the length of time that an Ambient IoT Device needs be “awake” by sending and receiving data on behalf of an third party Application Server. Since the Ambient IoT service is deployed in the network it can be expected that it resides relatively closer to the Ambient IoT Device than the third party Application Server.

Ambient IoT Devices may send data to a network and receive data from a network. The procedures that are presented in this document are particularly well suited for Ambient IoT Devices that harvest energy and have very limited energy storage. For example, such a device might harvest energy from RF signals, store the energy in a capacitor, and quickly perform some action before returning to a sleep, or inactive, or low power state. The procedures described are well suited for such a device because the procedure design emphasizes allowing interactions between the WTRU and network to take place quickly. One example of why quickly completing procedures with an energy harvesting device is important is that the energy that is stored in the device's capacitor may dissipate, or “run out”, if the procedure takes too long. Thus, the procedure may not complete before the device's runs out of energy.

Also, Ambient IoT Service may be deployed by a mobile network operator inside of an Application Server or a Network Function. A service may interact with Ambient IoT Devices on behalf of a third party Application Server. Thus, the third Party Application Server, which may run software such as inventory management software, does not need to understand the specifics of how to interact with the Ambient IoT Devices. Interaction with the Ambient IoT Devices may be performed by the network and the Ambient IoT Service.

Activation signals that on convey information to a WTRU are discussed herein. A base station may broadcast activation signals. The activation signals may be received by WTRU(s). A WTRU may be equipped with circuitry that is designed to harvest energy from the activation signals and store the energy in a component such as a battery or a capacitor.

A base station may broadcast and a WTRU may receive different types of activation signals. For example, a first type of activation signal may indicate to the WTRU that the purpose of the signal is only to provide energy to the WTRU and that the WTRU is not permitted to send MO data to the network and is not required to receive MT data from the network. For example, a second type of activation signal may indicate to the WTRU that the WTRU is permitted to send MO data to the network. For example, a third type of activation signal may indicate to the WTRU that the WTRU is required to receive MT data from the network.

The WTRU may be equipped with circuitry to harvest energy from all types of activation signals. An advantage of a system that includes multiple types of activation signals may be that the harvesting signal itself may be used to help the WTRU to avoid situations where the WTRU consumes energy by attempting to send data to the network that is not needed and avoid situations where the WTRU attempts to acquire data from the network (e.g. begins a paging reception process) when the network has no data to send to the network. Since MO data attempts and attempting to receiving MT data consumes WTRU energy and may generate network traffic, the overall system efficiency may be improved in terms of consumption of energy and network resources (i.e. spectrum).

The activation signal may be an analog signal. The shape, pattern, or frequency of the waveform may indicate to the WTRU what type of signal the waveform is. For example, each type of activation signal may be characterized by different shapes, patterns, or frequencies and the WTRU may be able to distinguish between the types of activation signals.

A base station may broadcast and a WTRU may receive other types of activation signals. For example, a base station may broadcast and a WTRU may receive an activation signal that indicates that certain groups of devices should respond with MO data or expect to receive MT data. For example, a base station may broadcast and a WTRU may receive an activation signal that indicates that certain devices should listen for broadcasted data (e.g. system information). For example, a base station may broadcast and a WTRU may receive an activation signal that indicates that certain groups of devices should expect to receive MT data that provides the UE with configuration information from the 5G system. For example, a base station may broadcast and a WTRU may receive an activation signal that indicates that the WTRU should not attempt to receive or send data. This type of signal may be useful because the WTRU may still harvest energy from the signal and use the harvested energy to perform device, or application, specific actions such as acquire a sensor reading.

A WTRU may be configured to detect the different types of activation signals and the system may send configuration information to configure the WTRU to know how to interpret each type of activation signal. For example, a device may be configured to know that when activation signal type 2 is detected, the device is permitted to send MO data. Such configuration capability results in a more flexible system design. For example, different devices could be configured to interpret different activation signals as a request to send MO data. This approach will help to avoid situations where many devices attempt to send MO data at this same time. Configuring a device for how to interpret an activation signal is discussed further herein.

Ambient IoT Service is described herein. A mobile network operator may deploy an Ambient IoT Service (AIS). An Ambient IoT Service is functionality that may be executed, or provided, by a Server or a Network Function.

The Ambient IoT Service may have a northbound API that may be accessed by third party Application Servers. The northbound API may allow third party Application Servers (AS) to access APIs that allow the third party Application Server to perform the following actions.

A first action may be to request to be associated with Ambient IoT Devices (i.e. UEs). This API may allow the AS to indicate the identity of the WTRUs that should be associated with the AS. The identity may be an External Identifier or an External Group Identifier. This API may allow the AS to indicate a location where the devices are expected to be found. This API may trigger the AIS to perform a procedure with the UDM/UDR to check that the AS is authorized to access the devices and the location.

A second action may be to request to collect MO data from Ambient IoT Devices (i.e., WTRUs). This API may be call AIS-NB MO Request. This API may allow the AS to indicate the identity of the WTRUs that the AS wants to collect MO data from. The identity may be an External Identifier or an External Group Identifier. This API may allow the AS to indicate a location where the devices are expected to be found. This API may also allow the AS to indicate a timeframe for when the AS would like a response. For example, the AS may indicate that data may be collected from the devices over the next hour. The AS may collect replies from the many devices that are identified by the External Group Identifier and, after the duration of one hour, the AS may send a notification to the AS. The notification to the AS may indicate that the data has been collected, the notification may also include the collected data or a location (e.g., a URI) of where the data can be read from.

Third, request to send MT data to Ambient IoT Devices (i.e., WTRUs). This API may be call AIS-NB MT Request. This API may allow the AS to indicate the identity of the WTRUs that the AS wants to send MT data to and may provide the data to be delivered. The identity may be an External Identifier or an External Group Identifier. This API may allow the AS to indicate a location where the devices are expected to be found. This API may also allow the AS to indicate a timeframe for how long the AS should attempt to send the MT data before stopping MT data delivery attempt. For example, the AS may indicate that data delivery may be attempted over the next hour. The AS may attempt to deliver the MT data to the many devices that are identified by the External Group Identifier and, after the duration of one hour, the AS may send a notification to the AS. The notification to the AS may indicate the identities of the devices that the data was successfully delivered to, the notification may also include a location (e.g., a URI) of a list of device identities that successfully, or unsuccessfully, received the data.

Fourth, request to broadcast an energy harvesting signal in an area. The purpose of signal may to provide a source of energy to an Ambient IoT Device (WTRU) so that the WTRU can perform some device specific action such as acquire a sensor reading without sending or receiving data from the network.

The Ambient IoT Service may have southbound interfaces that may be used to authorize request from the AS, send MT data towards Ambient IoT Devices, receive MO data from Ambient IoT Devices, and secure (e.g., authenticate and authorize) interactions with the Ambient IoT Devices. The Ambient IoT Service southbound interfaces may consist of APIs that are exposed by Network Functions that are in the 5G Core Network (e.g. AMF, UDM, and UDR APIs).

Mobile originated data transmission is discussed herein, including an example procedure where the Ambient IoT Service is used to collect MO Data from a device. In the example, the WTRU (Ambient IoT Device) detects an activation signal, harvests energy from the activation signal, and uses the activation signal to determine whether it should transmit MO data to an Ambient IoT Service. The procedure also described how the Ambient IoT Service can receive the MO data.

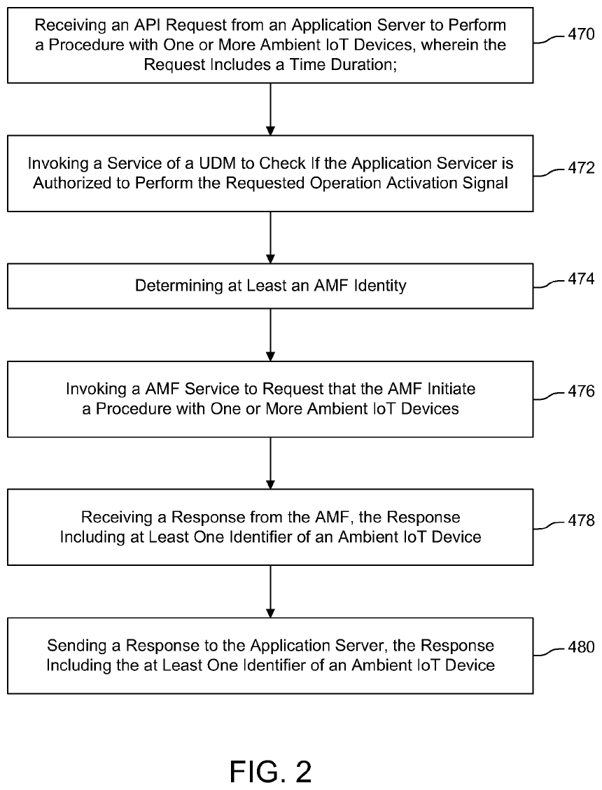

An exemplary process for an Ambient IoT service that runs on an application server or a network function is described below with respect to FIG. 2.

At 470 the procedure begins with the network node receiving an API request from an application server to perform a procedure with one or more ambient IoT devices. The request may include a time duration. At 472, the network node invokes service of a UDM to check if the application servicer is authorized to perform the requested operation. At 474, the network node determines at least an AMF identity. At 476, the network node invokes an AMF service to request that the AMF initiate a procedure with one or more ambient IoT devices. At 478, a response is received from the AMF, the response may include at least one identifier of an Ambient IoT device. At 480, the network nodes sends a response to the application server, the response including the at least one identifier of an Ambient IoT device. The API request may include location information, or Ambient IoT Device identifiers. The location information may be used to determine at least one AMF identity. The procedure that is requested in the API request may be a mobile originating (MO) data collection procedure.

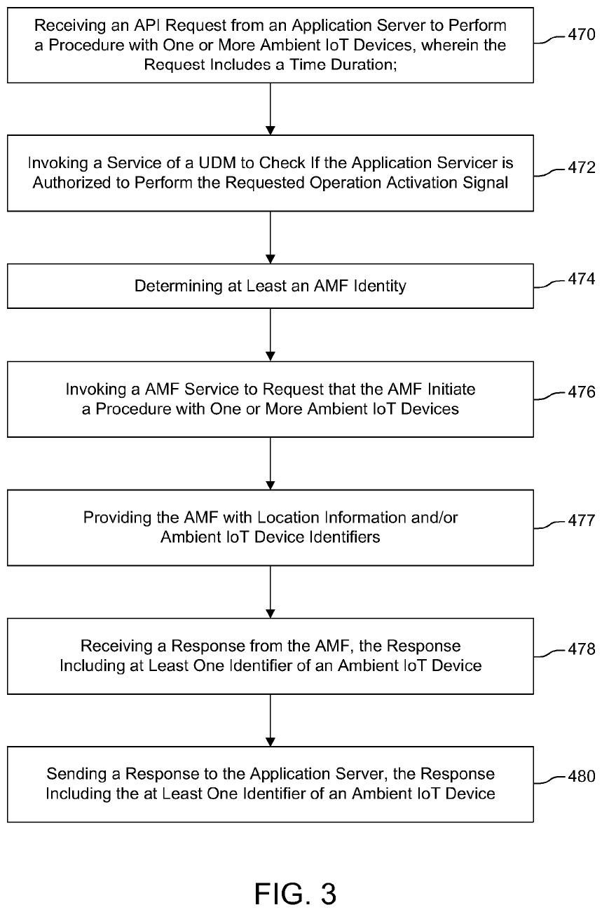

A further exemplary process for an Ambient IoT service that runs on an application server or a network function is described below with respect to FIG. 4B. Blocks 470, 472, 474, 476, 478 and 480 are as described above with respect to FIG. 2. FIG. 3 further describes that at 447, the AMF is provided with location information and/or Ambient IoT device identifiers.

Different types of configuration information are described herein.

The Configuration Information may include an Activation Signal Type to Action mapping IE. For example, this IE may indicate to the WTRU how it should interpret each type of activation signal. For example, the network may provide configuration that tells a first WTRU that a first type of activation signal should be interpreted an opportunity to harvest energy and begin a procedure that involves sending MO Data to the network. The network may also configure a second WTRU such that the first type of activation signal should be interpreted an opportunity to harvest energy only and not an opportunity to send MO Data to the network. Such an approach to configuration will help to avoid situations where many devices attempt to interact with the network at the same time.

In a system that supports three types of Activation Signals, it may be expected that the IE will configure the WTRU with information for how to interpret each of the three types of activation signals.

In the example above, one type of activation signal is configured to be interpreted by one WTRU as a chance to send MO Data. However, it should be understood that the IE can configure the WTRU to know that multiple types of actions are permissible after receiving some types of activation signals. For example, the WTRU may be configured to interpret Activation Signal Type 3 as an opportunity send data to the network or receive data from the network.

The Configuration Information may include an Exception Data Allowed IE. As described above, a combination of activation signal type and broadcast information may be interpreted by a WTRU as an indication to the WTRU that the network prefers that the WTRU not initiate a procedure where MO Data is sent to the network. The Exception Data Allowed IE may be used by the network to provide an indication to the WTRU of whether or not the WTRU is allowed to override this network preference and initiate procedure to send MO data to the network. For example, a WTRU may determine to override the network preference if a sensor reading is in a critical range and the Exception Data Allowed IE indicates that overriding the network's preference is allowed.

The Configuration Information may include a Broadcast Mask, or flag-mask, IE. As described earlier, the WTRU may read broadcast information to determine if the purpose of the activation signal is to initiate a procedure between the WTRU and the Network (e.g., send MT Data or receive MO Data).

The Configuration Information may include a Broadcast Mask and when the WTRU reads the broadcasted information the WTRU may perform a logical AND operation with the mask and the broadcasted information. The WTRU may use the result of the operation to determine if the WTRU should perform some action. For example, if the result of AND'ing the multi-bit mask and the multi-bit broadcast information results in a value of all 0's, then the WTRU may determine to perform no procedure to send or receive data. If the result of AND'ing the multi-bit mask and the multi-bit broadcast information results in a value of something other than all 0's, then the WTRU may determine to perform a procedure to send or receive data.

The WTRU may be configured with multiple mask values and each mask value may be associated with different broadcasted information. For example, one mask value may be used to read a broadcast message that indicates which devices should attempt to send data and another mask value may be used to read a broadcast message that indicates which devices should attempt to receive data.

The Configuration Information may include an AIS Identifier IE. The AIS Identifier may consist of an MNO ID (i.e. a PLMN ID) and an AIS Identifier Instance ID. The AIS Identifier Instance ID is assigned by the mobile network operator. The WTRU may be configured with multiple AIS Identifiers. The WTRU may determine which AIS identifier to use by reading the PLMN ID that is broadcasted by the base station with which the WTRU is communicating. When the WTRU has no AIS Identifier configured that is associated with the PLMN ID of the base station, then the WTRU may determine to not communicate with the base station and attempt to establish communication with a different base station.

The Configuration Information may include URSP IEs. URSP Rules are described in 3GPP standards and are used by WTRUs to associate application traffic with a PDU Session. Since an Ambient IoT Device may send MO and MT Data outside of any PDU Session, the URSP Rules that are provided to the Ambient IoT device may include rules that can be used by the WTRU to map application traffic to an AIS Identifier. For example, the URSP Rule may include a traffic descriptor that points to an AIS ID. In other words, traffic that matches the traffic descriptor should be sent to the indicated AIS ID. The WTRU may be provided URSP Rules with a PLMN ID and may use the PLMN ID that is broadcasted by the base station to determine which set of PLMN Rules to use.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a network node of providing an Ambient IoT service (AIS), the method comprising:
receiving an Application Programming Interface (API) request from an application server to perform a procedure with one or more ambient IoT devices, wherein the request includes a time duration;
invoking a service of a User Data Manager (UDM) to check if the application servicer is authorized to perform the requested operation;
determining at least an Access and Mobility (AMF) identity;
invoking a AMF service to request that the AMF initiate a procedure with one or more ambient IoT devices;
receiving a response from the AMF, the response including at least one identifier of an ambient IoT device; and
sending a response to the application server, the response including the at least one identifier of an ambient IoT device.

2. The method of claim 1, wherein the API request includes location information, or ambient IoT device identifiers.

3. The method of claim 2, wherein the location information is used to determine at least one AMF identity.

4. The method of claim 1, wherein the procedure that is requested in the API request is a mobile originating (MO) data collection procedure.

5. The method of claim 1 further comprising: providing the AMF with location information and/or ambient IoT device identifiers.

6. The method of claim 1, wherein the response from the AMF service includes at least an ambient IoT device identity and MO data.

7. The method of claim 1, wherein the response from the AMF Service includes at least an ambient IoT device identity and an indication of whether MT data was delivered to the ambient IoT device or the location of the ambient IoT device.

8. The method of claim 1, wherein the response to the Application Server includes at least an ambient IoT device identity and an indication of whether MT data was delivered to the ambient IoT device or the location of the ambient IoT device.

9. The method of claim 2, wherein the location information includes a last known location of at least one of the ambient IoT devices and wherein the AMF identity is determined based on the last known location of at the least one of the ambient IoT devices.

10. A network node for providing an Ambient IoT service (AIS), the network node being configured to:
receive an Application Programming Interface (API) request from an application server to perform a procedure with one or more ambient IoT devices, wherein the request includes a time duration;
invoke a service of a User Data Manager (UDM) to check if the application servicer is authorized to perform the requested operation;
determine at least an Access and Mobility (AMF) identity;
invoke a AMF service to request that the AMF initiate a procedure with one or more ambient IoT devices;
receive a response from the AMF, the response including at least one identifier of an ambient IoT device; and
send a response to the application server, the response including the at least one identifier of an ambient IoT device.

11. The network node of claim 10, wherein the API request includes location information, or ambient IoT device identifiers.

12. The network node of claim 11, wherein the location information is used to determine at least one AMF identity.

13. The network node of claim 1, wherein the procedure that is requested in the API request is a mobile originating (MO) data collection procedure.

14. The network node of claim 10 further configured to provide the AMF with location information and/or Ambient IoT device identifiers.

15. The network node of claim 10, wherein the response from the AMF service includes at least an Ambient IoT device identity and MO data.

16. The network node of claim 10, wherein the response from the AMF Service includes at least an Ambient IoT Device identity and an indication of whether MT data was delivered to the Ambient IoT Device or the location of the Ambient IoT Device.

17. The network node of claim 10, wherein the response to the Application Server includes at least an Ambient IoT Device identity and an indication of whether MT data was delivered to the Ambient IoT Device or the location of the Ambient IoT Device.

18. The network node of claim 10, wherein the location information includes a last known location of at least one of the ambient IoT devices and wherein the AMF identity is determined based on the last known location of at the least one of the ambient IoT devices.

19. The network node of claim 10 wherein the network node is an application server.

20. The network node of claim 10 wherein the network node is network function.
